(19) United States
(12) Patent Application Publication
(10) Pub. No.: US 2024/0336250 A1
(43) Pub. Date: Oct. 10, 2024

(54) CONTROL UNIT OF AN AUTOMATIC GEARBOX, ASSOCIATED METHOD AND VEHICLE

(71) Applicant: RENAULT S.A.S, Boulogne Billancourt (FR)

(72) Inventors: Vasileios KONTOPOULOS, Lardy (FR); Aurelien LEFEVRE, Lardy (FR)

(73) Assignee: RENAULT S.A.S, Boulogne Billancourt (FR)

(21) Appl. No.: 18/294,316

(22) PCT Filed: Jul. 25, 2022
(86) PCT No.: PCT/EP2022/070830

§ 371 Date: Feb. 1, 2024

(30) Foreign Application Priority Data
Aug. 3, 2021 (FR) 2108436

(51) Int. Cl. B60W 10/26

(52) U.S. Cl. CPC B60W 10/26; B60W 2510/244; B60W 2520/10; B60W 2710/083

(57) ABSTRACT

A control unit of an automatic gearbox for a hybrid motor vehicle includes a first selector, a second selector, an identifier to identify at least one state of a series hybrid drivetrain so as to generate a vehicle deceleration equal to a vehicle deceleration setpoint, a determination unit to determine a control vector for the gearbox according to the drivetrain state selected by the first and second selectors, and the result of the identification of the identifier, and a controller to control the gearbox according to the control vector.

The present invention relates to a gearbox control unit for a hybrid motor vehicle.

The present invention relates more particularly to a gearbox control unit for a motor vehicle having a series hybrid mode, to a method for implementing such a unit and to a hybrid motor vehicle comprising an automatic gearbox controlled by such a unit.

In general, a hybrid motor vehicle comprises a propulsion unit comprising an electric traction motor associated with a battery, a combustion engine and gearbox connecting said motor and engine to wheels that propel the vehicle.

Conventionally, the propulsion unit can be controlled in an exclusively electrical mode of operation in which the combustion engine is uncoupled from the gearbox and the electric traction motor is connected to the wheels of the vehicle.

During vehicle deceleration phases controlled for example by the driver of the vehicle, the propulsion unit operates exclusively electrically.

The electric traction motor, driven by the wheels, operates in electrical-energy generator mode and charges the battery, the uncoupled combustion engine consuming no mechanical power. The recovery of the kinetic energy of deceleration of the vehicle in the form of electrical energy is thus optimized.

Furthermore, operating a vehicle in exclusively electrical mode during the phases of deceleration improves the drivability.

However, during deceleration phases, the battery may be incapable of storing the electrical energy produced by the electric traction machine in generator mode, notably when the battery is full or defective.

When the battery no longer has the capacity to store energy, the electric traction machine no longer generates resistive torque (“engine braking”) on the wheels, which means that the vehicle does not decelerate.

It is therefore necessary to select a driveline state for the propulsion unit that enables the vehicle to be decelerated as demanded by the driver.

It will be recalled that a driveline state is defined by a combination of the state(s) of (a) coupler(s) and of the state(s) of (a) reduction gearbox(es) specific to a given design of a vehicle's propulsion unit.

For a combustion engine gearbox, one driveline state is, for example, a state in which a first reduction gear is engaged and a clutch between the combustion engine and the gearbox is closed (engaged). For a gearbox of a hybrid vehicle, a driveline state corresponds for example to a clutch between the combustion engine and the gearbox connected to the front wheels being open (disengaged) with the electric motors propelling the vehicle via the rear wheels.

The proposal therefore is to alleviate all or some of the disadvantages of hybrid vehicle propulsion units according to the prior art in the deceleration phases, notably by improving the deceleration of the vehicle when the battery does not have the capacity to absorb all of the electrical energy produced by the electric traction motor.

In view of the above, one subject of the invention is a method for controlling an automatic gearbox for a motor vehicle, comprising:
a first selection of a driveline state from between an electrical driveline state in which an electric traction motor is connected to the wheels of the vehicle via said gearbox and to a traction battery, and a series hybrid driveline state in which the electric traction motor is also electrically connected to an additional electric motor mechanically connected to a propulsion combustion engine, the selection of the driveline state being made on the basis of a target deceleration setpoint, the coupling losses, and on the basis of the state of charge of the traction battery.
a second selection of a driveline state from between a series hybrid driveline state and a combustion engine driveline state in which the combustion engine is connected to the wheels via the gearbox on the basis of the speed of the vehicle, of the minimum deceleration values of the driveline states and of a gearbox control setpoint,
the identification of at least one series hybrid driveline state so as to generate a vehicle deceleration that is equal to a deceleration setpoint for the vehicle,
the determining of a control vector for control of the gearbox, comprising at least one driveline state according to the driveline state selected as a result of the first and second selections, and according to the result of the identification, and wherein the gearbox is controlled on the basis of the determined driveline state so that a first proportion of the energy generated by the electric traction motor driven by the wheels is stored in the traction battery, and a second proportion of the energy powers the additional electric motor that drives the combustion engine if the driveline state determined is a series hybrid driveline state.

Another subject of the invention is a control unit controlling an automatic gearbox for a hybrid motor vehicle, comprising:
first selection means configured to select a driveline state from between an electrical driveline state,
second selection means configured to select a type of driveline from between a series hybrid driveline state and a combustion engine driveline state,
identification means configured to identify at least one series hybrid driveline state so as to generate a vehicle deceleration that is equal to a deceleration setpoint for the vehicle,
determination means configured to determine a control vector for the gearbox comprising at least one driveline state on the basis of the driveline state selected by the first and second selection means and the result of the identification from the identification means, and
control means configured to control the gearbox on the basis of the control vector so that a first proportion of the energy generated by the electric traction motor driven by the wheels is stored in the traction battery, and a second proportion of the energy powers the additional electric motor driving the combustion engine when the driveline state is a series hybrid driveline state if the control vector comprises a series hybrid driveline state.

Yet another subject of the invention is a hybrid motor vehicle comprising a control unit as defined hereinabove, an automatic gearbox driving wheels of the vehicle and controlled by the control unit, an electric traction motor connected mechanically to the gearbox, a propulsion combustion engine connected mechanically to the gearbox, an additional electric motor connected mechanically to the propulsion combustion engine, and a traction battery connected to the propulsion motor and additional motor.

Other aims, features and advantages of the invention will become apparent on reading the following description, which is given merely by way of non-limiting example, and with reference to the appended drawings, in which:

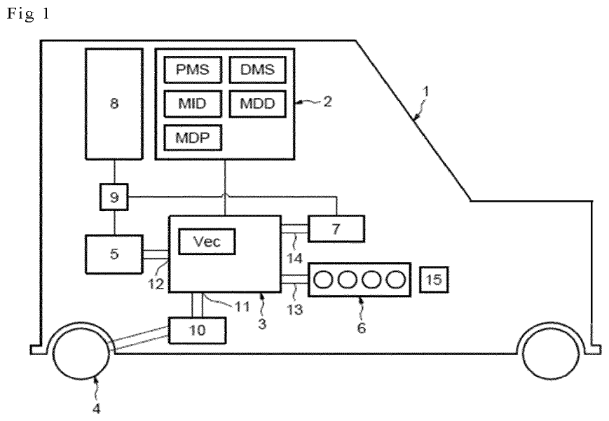

FIG. 1 schematically illustrates a hybrid motor vehicle according to the invention; and

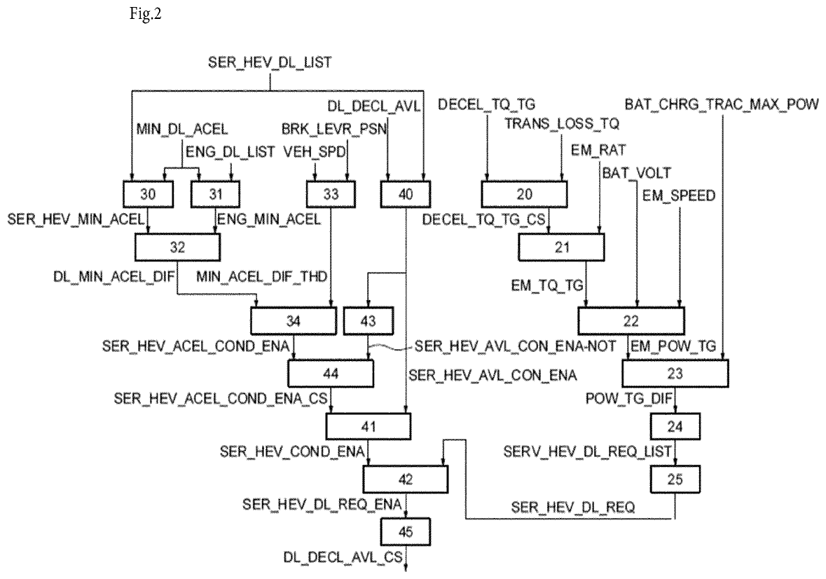

FIG. 2 schematically illustrates one exemplary embodiment of an automatic-gearbox control unit according to the invention.

The hybrid motor vehicle 1 comprises a control unit 2, an automatic gearbox 3 driving wheels 4 of the vehicle and controlled by the control unit 2, an electric traction motor 5 connected mechanically to the gearbox 3, a propulsion combustion engine 6 connected mechanically to the gearbox 3, an additional electric motor 7 connected mechanically to the propulsion combustion engine 6, and a traction battery 8 connected to the propulsion motor 6 and additional motor 7.

The additional electric motor 7 is connected to the combustion engine 6 via the gearbox 3.

As a variant, the additional electric motor 7 may be connected to the combustion engine 6 via a clutch external to the gearbox or via a permanent transmission means.

The vehicle 1 may further comprise a power controller 9 controlling the flows of electrical energy between the electric traction motor 5, the additional electric motor 7 and the battery 8, and a differential 10 connecting an output 11 of the gearbox to the wheels 4.

The gearbox 3 comprises a first input 12 connected to the electric traction motor 5, a second input 13 connected to the combustion engine 6 and a third input 14 connected to the additional electric motor 7.

The gearbox 3 comprises series hybrid driveline states EcH in which the electric traction motor 5 is mechanically connected to the wheels 4, the additional electric motor is connected to the combustion engine 6 which is not mechanically connected to the wheels 4, electric driveline states EcE in which only the electric traction motor 5 is mechanically connected to the wheels 4, and hybrid driveline states EcT in which the combustion engine 6 is mechanically connected to the wheels 4, the traction motor 5 either being or not being mechanically connected to the wheels 4.

The driveline states EcH, EcE and EcT form a driveline states vector VeC. It is assumed that the gearbox 3 comprises two series hybrid driveline states EcH1 and EcH2 having respective gearing ratios IcH1 and IcH2 between the first input 12 and the wheels 4, two electrical driveline states EcE1 and EcE2 having respective gearing ratios IcE1 and IcE2, and six combustion engine driveline states EcT1, EcT2, EcT3, EcT4, EcT5 and EcT6 having respective gearing ratios IcT1, IcT2, IcT3, IcT4, IcT5 and IcT6.

The combustion engine driveline states EcT1, EcT2 correspond to exclusive mechanical connection between the wheels 4 and the combustion engine 6, the combustion engine driveline states EcT3, EcT4 correspond to a mechanical connection between the wheels 4 and the combustion engine 6 with the gearing ratio IcT1 and a mechanical connection between the wheels 4 and the traction motor 5 with the gearing ratio IcE1 and IcE2, and the combustion engine driveline states EcT5, EcT6 correspond to a mechanical connection between the wheels 4 and the combustion engine 6 with the gearing ratio IcT2 and a mechanical connection between the wheels 4 and the traction motor 5 with the gearing ratio IcE1 and IcE2.

The driveline states vector VeC is equal to:

$$VeC = ( \begin{matrix}EcH 1 \\ EcH 2 \\ EcE 1 \\ EcE 2 \\ EcT 1 \\ EcT 2 \\ EcT 3 \\ EcT 4 \\ EcT 5 \\ EcT 6\end{matrix} ) \qquad ( 1 )$$

The vector of the gearing ratios of the electric traction machine in the series hybrid driveline states EcH1 and EcH2 is denoted EM_RAT:

$$EM\_RAT = ( \begin{matrix}IcH 1 \\ IcH 2\end{matrix} ) \qquad ( 2 )$$

Of course, the number of series hybrid driveline states EcH, electrical driveline states EcE and combustion engine driveline states EcT may be different, there being at least one of each driveline state EcH, EcE, EcT.

The control unit 2 comprises:
first selection means PMS for selecting a driveline state from between an electrical driveline state EcE, and a series hybrid driveline state EcH, on the basis of a target deceleration setpoint, the coupling losses TRANS_LOSS_TQ, and on the basis of the state of charge of the traction battery 8. The state of charge of the battery 8 is determined on the basis of the voltage BAT_VOLT across its terminals,
second selection means DMS for selecting a type of driveline from between a series hybrid driveline state EcH and a combustion engine driveline state EcT on the basis of the speed of the vehicle VEH_SPD, of the minimum deceleration values of the driveline states MIN_DL_ACEL and of a gearbox control setpoint BRK_LEVR_PSN for the gearbox 3,
identification means MID for identifying at least one series hybrid driveline state EcH so as to generate a vehicle deceleration that is equal to a deceleration setpoint for the vehicle,
determination means MDD for determining a control vector DL_DECL_AVL_CS for the gearbox comprising at least one driveline state on the basis of the driveline state selected by the first and second selection means PMS, DMS and the result of the identification from the identification means MID, and
control means MDP for controlling the gearbox 3 on the basis of the control vector DL_DECL_AVL_CS so that a first proportion of the energy generated by the electric traction motor 5 driven by the wheels 4 is stored in the traction battery 8, and a second proportion of the energy generated powers the additional electric motor 7 driving the combustion engine 6 when the driveline state is a series hybrid driveline state EcH.

The vehicle deceleration setpoint comprises a first Boolean vector DL_DECL_AVL in which the driveline states producing a minimum deceleration equal to a vehicle required deceleration setpoint for the vehicle, said setpoint being provided for example by a processor belonging to the vehicle and determined by a table of deceleration values on the basis of the control setpoint BRK_LEVR_PSN for the gearbox 3. The high logic state, for example “1”, for the vector DL_DECL_AVL indicates that a driveline state produces the required deceleration.

The target deceleration setpoint comprises a deceleration vector DECEL_TQ_TG comprising target deceleration torques at the wheels 4 which are associated with the series hybrid driveline states EcH1, EcH2.

If a hybrid driveline state is not compatible with the vehicle speed VEH_SPD, the value of the torque of said state is for example zero.

$$DECEL\_TQ \_TG = ( \begin{matrix}EcH 1 \\ EcH 2\end{matrix} ) \qquad ( 3 )$$

The maximum charging power of the battery 8 which is equal to the maximum battery recharging power added to the electrical consumption of the electrical accessories of the vehicle 1 is denoted BAT_CHRG_TRAC_MAX_POW, the speed vector for the rotational speeds of the electric traction machine 5 in the series hybrid states EcH1, EcH2 and calculated from the driveline state gearing ratios IcH1, IcH2 and from the vehicle speed VEH_SPD is denoted EM_SPEED, and the vector of the torque losses associated with the coupling of the electric traction machine 5 in the series hybrid states EcH1, EcH2 is denoted TRANS_LOSS_TQ.

The vectors DECEL_TQ_TG, TRANS_LOSS_TQ, MIN_DL_ACEL, and the control setpoint BRK_LEVR_PSN are transmitted by an engine control processor 15.

The control setpoint BRK_LEVR_PSN is transmitted to the engine control processor 15 by the driver of the vehicle 1 via a human-machine interface comprising for example a gearshift lever, a button or paddles situated on the steering wheel.

A second Boolean vector indicating the coordinates of the series hybrid driveline states is denoted SER_HEV_DL_LIST.

The high logic state, for example “1”, in the vector SER_HEV_DL_LIST indicates the series hybrid driveline states:

$$SER\_HEV \_DL \_LIST = ( \begin{matrix}1 \\ 1 \\ 0 \\ 0 \\ 0 \\ 0 \\ 0 \\ 0 \\ 0 \\ 0\end{matrix} ) \qquad ( 4 )$$

A third Boolean vector indicating the coordinates of the combustion engine driveline states EcT is denoted ENG_DL_LIST. The high logic state, for example “1”, indicates the combustion engine driveline states:

$$ENG\_DL \_LIST = ( \begin{matrix}0 \\ 0 \\ 0 \\ 0 \\ 1 \\ 1 \\ 1 \\ 1 \\ 1 \\ 1\end{matrix} ) \qquad ( 5 )$$

FIG. 2 illustrates one exemplary embodiment of the control unit 2.

The first means PMS select a driveline state from between an electrical driveline state and a series hybrid driveline state (steps 20 to 25). The steps are now presented in detail.

The first means PMS determine whether a proportion of the energy recovered from the deceleration of the vehicle 1 needs to be dissipated by turning over the combustion engine 6 driven by the additional electric motor 7 by selecting a series hybrid driveline state in order to ensure that the vehicle 1 decelerates.

The first means PMS determine a target torque setpoint EM_TQ_TG for the electric traction machine for each series hybrid driveline state EcH1, EcH2 (steps 20 and 21).

The torque setpoint vector EM_TQ_TG is determined from the target deceleration setpoint DECEL_TQ_TG, from the gearing ratio EM_RAT of said series hybrid driveline state and from the coupling losses vector TRANS_LOSS_TQ.

In step 20, the first means PMS determine a target torque DECEL_TQ_TG_CS at the wheels 4 for each state EcH1, EcH2, according to the following equation:

DECEL_TQ_TG_CS=DECEL_TQ_TG−TRANS_LOSS_TQ (6)

Then, during step 21, the first means PMS determine the torque setpoint EM_TQ_TG for the torque on the shaft of the traction machine 5, using the following equation:

$$EM\_TQ \_TG = DECEL\_TQ \_TG \_CS / EM\_RAT \qquad ( 7 )$$

For each series hybrid driveline state, the first means PMS determine an excess electrical power POW_TG_DIFF equal to the difference between the power EM_POW_TG of the electric traction machine 5 that is generated as a function of the torque setpoint EM_TQ_TG, of the vehicle speed EM_SPEED and of the battery voltage BAT_VOLT, and the storage capacity BAT_CHRG_TRAC_MAX_POW of the traction battery 8 (steps 22 and 23). To do that, during step 22, and using the torque setpoint EM_TQ_TG, the voltage BAT_VOLT and the speed EM_SPEED, the first means PMS determine the electrical power EM_POW_TG for each state EcH1, EcH2 using the following equation:

$$EM\_POW \_TG = EM\_POW \_LOSS + EM\_POW \_EFF * EM\_TQ \_TG \qquad ( 8 )$$

where EM_POW_LOSS and EM_POW_EFF are coefficients characteristic of the losses and of the useful power of the machine 5 as determined on the basis of the voltage BAT_VOLT and of the speed EM_SPEED, the coefficient EM_POW_LOSS having the units of Watts and the coefficient EM_POW_EFF having the units of Watts per Newton-meter.

Then, during step 23, first means PMS determine the excess electrical power POW_TG_DIFF for each state EcH1, EcH2:

$$POW\_TG \_DIFF = EM\_POW \_TG - BAT\_CHRG \_TRAC \_MAX \_POW \qquad ( 9 )$$

In step 24, the first means PMS compare the excess electrical power POW_TG_DIFF for each series hybrid driveline state EcH1, EcH2 against power thresholds POW_TG_DIF_THD_H and POW_TG_DIF_THD_L, the value of POW_TG_DIF_THD_H being greater than that of the threshold POW_TG_DIF_THD_L so as to define a Boolean vector SER_HEV_DL_REQ_LIST indicative of the series hybrid driveline states EcH1, EcH2 able to consume a proportion of the electrical energy generated by the electric traction machine 5 by using the additional electrical machine 7 to drive the combustion engine 6 in order to dissipate that proportion of the electrical energy in the form of heat dissipated by the engine 6.

If the excess electrical power POW_TG_DIFF is above the threshold POW_TG_DIF_THD_H, the value of the coordinate of the associated series hybrid driveline state EcH1, EcH2 is equal to the high logic state, for example “1”.

As soon as the excess electrical power POW_TG_DIFF drops below the threshold POW_TG_DIF_THD_L, the value of the coordinate of the associated series hybrid driveline state EcH1, EcH2 is equal to the low logic state, for example “0)”.

If the excess electrical power POW_TG_DIFF is below the threshold POW_TG_DIF_THD_L, the value of the coordinate of the associated series hybrid driveline state EcH1, EcH2 is equal to the low logic state, for example “0”.

As soon as the excess electrical power POW_TG_DIFF rises above the threshold POW_TG_DIF_THD_H, the value of the coordinate of the associated series hybrid driveline state EcH1, EcH2 is equal to the high logic state, for example “1”.

The thresholds POW_TG_DIF_THD_H and POW_TG_DIF_THD_L are defined empirically so as to achieve the best compromise in terms of drivability for the transition from an electrical driveline state to a series hybrid driveline state and vice versa.

In step 25, the first means PMS perform a third selection of a driveline state from between a series hybrid driveline state and an electrical driveline state on the basis of the coordinates of the Boolean vector SER_HEV_DL_REQ_LIST.

The first means PMS determine a Boolean request vector SER_HEV_DL_REQ requesting the use of series hybrid states.

If at least one of the coordinates of the Boolean vector SER_HEV_DL_REQ_LIST is in the high logic state, for example “1”, the Boolean SER_HEV_DL_REQ is in the high logic state, for example “1”, so that the series hybrid driveline state is selected by the first means PMS.

If none of the coordinates of the Boolean vector SER_HEV_DL_REQ_LIST is in the high logic state, for example “1”, the Boolean SER_HEV_DL_REQ is in the low logic state, for example “0)”, so that the electrical driveline state is selected by the first means PMS.

The second means DMS select a driveline state from between a combustion engine driveline state EcT1 to EcT6 and a series hybrid driveline state EcH1, EcH2 on the basis of the speed of the vehicle VEH_SPD, of the minimum deceleration values MIN_DL_ACEL of the driveline states, and of a gearbox control setpoint BRK_LEVR_PSN for the gearbox 3 (steps 30 to 34).

The second means DMS calculate, for all of the series hybrid driveline states EcH1, EcH1 and combustion engine driveline states EcT1 to EcT6, the difference DL_MIN_ACEL_DIF between the minimum deceleration values of said series hybrid driveline state SER_HEV_MIN_ACEL and combustion engine driveline state ENG_MIN_ACEL (steps 30 to 32). The steps are now presented in detail.

During step 30, the second means DMS search within the vector MIN_DL_ACEL for the minimum deceleration value of the series hybrid driveline states by comparing the coordinates of said vector with those of the vector SER_HEV_DL_LIST indicating the series hybrid driveline states, and deliver the value SER_HEV_MIN_ACEL containing said minimum deceleration.

Similarly, during step 31, the second means DMS deliver values ENG_MIN_ACEL containing the minimum deceleration value of each combustion engine driveline state which are determined from the vectors MIN_DL_ACEL and ENG_DL_LIST.

During step 32, the values ENG_MIN_ACEL are subtracted from the value SER_HEV_MIN_ACEL in order to determine the surplus deceleration supplied by the minimum value of the minimum deceleration values of the series hybrid and combustion engine driveline states, the deceleration surplus being stored in a value DL_MIN_ACEL_DIF.

During step 33, the second means DMS determine a deceleration threshold MIN_ACEL_DIF_THD defined on the basis of the control setpoint BRK_LEVR_PSN for the gearbox 3 and of the speed VEH_SPD of the vehicle 1.

The threshold MIN_ACEL_DIF_THD is determined on the basis of predetermined tables stored for example in the unit 2 and linking the control setpoint BRK_LEVR_PSN for the gearbox 3 and the speed VEH_SPD of the vehicle 1 to said threshold.

During step 34, the second means DMS compare the value DL_MIN_ACEL_DIF with the deceleration threshold MIN_ACEL_DIF_THD so as to determine whether the difference in deceleration is significant enough to favor the series hybrid driveline states over the combustion engine driveline states.

If the value DL_MIN_ACEL_DIF is above the threshold MIN_ACEL_DIF_THD, the second means DMS generate a Boolean SER_HEV_ACEL_COND_ENA for example in the high logic state, for example “1”, and if it is not, then in the low logic state, for example “0”.

The high logic state of the Boolean SER_HEV_ACEL_COND_ENA is indicative of the series hybrid driveline state selected by the second means DMS, and the low logic state of the Boolean SER_HEV_ACEL_COND_ENA is indicative of the combustion engine driveline state selected by the second means DMS.

During steps 40 to 43, the identification means MID identify at least one series hybrid driveline state EcH so as to generate a vehicle deceleration equal to the vehicle deceleration setpoint, and the determination means MDD determine at least one driveline state on the basis of the driveline state selected by the first and second selection means PMS, DMS, and the result of the identification by the identification means MID.

During step 40, the identification means MID determine whether at least one series hybrid driveline state generates a vehicle deceleration that is equal to a deceleration setpoint for the vehicle 1.

The identification means MID determine whether the vectors SER_HEV_DL_LIST and DL_DECL_AVL each have at least one high logic state.

If the vector SER_HEV_DL_LIST and the vector DL_DECL_AVL each comprise at least one high logic state, the identification means MID generate a Boolean SER_HEV_AVL_COND_ENA in the high logic state indicative of a fifth selection of a series hybrid driveline state.

If not, the identification means MID generate the Boolean SER_HEV_AVL_COND_ENA in the low logic state indicative of a driveline state other than that of series hybrid type.

If the fifth selection comprises the series hybrid driveline state (step 40), the Boolean SER_HEV_AVL_COND_ENA is in the high logic state. The identification means MID in step 41 generate a Boolean SER_HEV_COND_ENA in the high state.

Then, in step 42, if the Boolean SER_HEV_DL_REQ is in the high logic state and since the Boolean SER_HEV_CON_ENA is in the high logic state, the identification means MID generate a Boolean SER_HEV_DL_REQ_ENA in the high logic state.

If the Boolean SER_HEV_DL_REQ is in the low logic state while at the same time the Boolean SER_HEV_DL_REQ is in the high logic state, the identification means MID generate a Boolean SER_HEV_DL_REQ_ENA in the low logic state.

If the Boolean SER_HEV_AVL_COND_ENA is in the low logic state, the identification means MID, in 43, the Boolean step generate SER_HEV_AVL_COND_ENA-NOT in the high logic state, or in the low logic state if the Boolean SER_HEV_AVL_COND_ENA is in the high logic state.

If, in step 44, the Boolean SER_HEV_ACEL_CON_ENA is in the low logic state or the Boolean SER_HEV_AVL_COND_ENA-NOT is in the low logic state, the means MID generate a Boolean SER_HEV_ACEL_CON_ENA_CS in the low logic state, and the identification means MID in step 41 generate the Boolean SER_HEV_COND_ENA in the low state and then the method continues to step 42.

If, in step 44, the Boolean SER_HEV_ACEL_CON_ENA is in the high logic state and the Boolean SER_HEV_AVL_COND_ENA-NOT is in the high state, the Boolean SER_HEV_CON_ENA in the high logic state, and the identification means MID in step 41 generate the Boolean SER_HEV_COND_ENA in the high logic state and then the method continues to step 42.

In step 42, if the Boolean SER_HEV_COND_ENA is in the low logic state or if the logic state of the Boolean SER_HEV_DL_REQ is low, the identification means MID generate the Boolean SER_HEV_DL_REQ_ENA in the low logic state.

In step 45, if the Boolean SER_HEV_DL_REQ_ENA is in the high logic state, the determination means MDD determine a control vector DL_DECL_AVL_CS containing all of the series hybrid, combustion engine and electrical driveline states, in which vector the coordinates of the series hybrid driveline states are activated and the coordinates associated with at least one driveline state other than series hybrid are deactivated, for example by assigning a low logic state, for example “0”, to the coordinates of the electrical and combustion engine driveline states.

$$DL\_DECL \_AVL \_CS = ( \begin{matrix}EcH 1 \\ EcH 2 \\ 0 \\ 0 \\ 0 \\ 0 \\ 0 \\ 0 \\ 0 \\ 0\end{matrix} ) \qquad ( 9 )$$

If the Boolean SER_HEV_DL_REQ_ENA is in the low logic state, the determination means MDD determine the control vector DL_DECL_AVL_CS in which the coordinates of all the driveline states producing a minimum deceleration equal to the vehicle deceleration setpoint are activated, and the coordinates of the remaining driveline states are deactivated, for example by assigning a low logic state, for example “0”, to said coordinates.

The control vector DL_DECL_AVL_CS is equal to the vector DL_DECL_AVL.

The vector DL_DECL_AVL_CS is determined by the determination means MDD from the vector DL_DECL_AVL containing all of the driveline states that produce a minimum deceleration equal to the vehicle deceleration setpoint.

If the vector DL_DECL_AVL_CS comprises several driveline states, the determination means MDD determine the electrical energy dissipated for each state of the control vector and then select the state that generates the lowest losses.

The driveline state selected or if just one driveline state is stored in the vector DL_DECL_AVL_CS is transmitted to the control means MDP which control the gearbox 3 on the basis of said driveline state.

If the driveline state transmitted to the control means MDP is a hybrid driveline state EcH1, EcH2, the control means MDP control the gearbox 3 in such a way that a first proportion of the energy generated by the electric traction motor 5 driven by the wheels 4 is stored in the traction battery 8, and a second proportion of the energy powers the additional electric motor 7 driving the combustion engine 6.

The method for controlling the automatic gearbox 3 makes it possible to improve the deceleration of the vehicle when the battery does not have the capacity to absorb all of the electrical energy produced by the electric traction motor, by dissipating energy into the combustion engine via the additional electric motor when a series hybrid driveline state is selected, with the result that the vehicle 1 does not require additional components in order to dissipate said energy.

Furthermore, the control method may be implemented on any hybrid vehicle comprising an automatic transmission with discreet ratio comprising a series hybrid driveline state and an electrical driveline state.

In addition, the method can be readily transferred to several types of gearbox.

1-10. (canceled)

11. A method for controlling an automatic gearbox for a hybrid motor vehicle, the method comprising:
selecting a driveline state, via a first selection, from between an electrical driveline state in which an electric traction motor is connected to wheels of the vehicle via said gearbox and to a traction battery, and a series hybrid driveline state in which the electric traction motor is also electrically connected to an additional electric motor mechanically connected to a propulsion combustion engine, the selecting the driveline state being made based on a target deceleration setpoint, coupling losses, and based on a state of charge of the traction battery;
selecting a type of driveline, via a second selection, from between a series hybrid driveline state and a combustion engine driveline state in which the combustion engine is connected to the wheels via the gearbox based on a speed of the vehicle, a minimum deceleration values of the driveline states, and a gearbox control setpoint;
identifying at least one series hybrid driveline state so as to generate a vehicle deceleration that is equal to a deceleration setpoint for the vehicle;
determining a control vector for control of the gearbox, comprising at least one driveline state according to the driveline state selected as a result of the first and second selections, and according to a result of the identifying; and
controlling the gearbox based on the determined driveline state so that a first proportion of energy generated by the electric traction motor driven by the wheels is stored in the traction battery, and a second proportion of the energy powers the additional electric motor that drives the combustion engine when the driveline state determined is a hybrid driveline state.

12. The method as claimed in claim 11, wherein the first selection comprises:
determining a torque setpoint for the electric traction machine for each series hybrid driveline state, the torque setpoint being determined from the target deceleration setpoint, the coupling losses and the gearing ratio of said series hybrid driveline state,
determining, for each series hybrid driveline state, an excess electrical power equal to a difference between the power of the electric traction machine that is generated as a function of the torque setpoint, of the vehicle speed, and of the voltage of the traction battery, and a storage capacity of the traction battery,
comparing the excess electrical power of each series hybrid driveline state against power thresholds, and
depending on a result of the comparing, a third selection of a driveline state from between a series hybrid driveline state and an electrical driveline state.

13. The method as claimed in claim 12, wherein when the excess electrical power of at least one series hybrid driveline state is above an upper power threshold, the third selection comprises the series hybrid driveline state, and when the excess electrical power of each series hybrid driveline state is below a lower power threshold lower than the upper power threshold, the third selection comprises the electrical driveline state.

14. The method as claimed in claim 11, wherein the second selection comprises:
calculating, for each series hybrid driveline state and each combustion engine driveline state, a difference between the minimum deceleration values of said series hybrid and combustion engine driveline states in order to determine the value of a surplus deceleration which is given by the minimum value of the minimum deceleration values of the series hybrid and combustion engine driveline states,
comparing the surplus deceleration value against a deceleration threshold defined based on the control setpoint for the gearbox and the speed of the vehicle, and
depending on a result of the comparing, a fourth selection of a driveline state from between a series hybrid driveline state and a combustion engine driveline state.

15. The method as claimed in claim 14, wherein when the minimum deceleration value of at least one series hybrid driveline state is above the deceleration threshold, the fourth selection comprises the series hybrid driveline state, otherwise the fourth selection comprises the combustion engine driveline state.

16. The method as claimed in claim 11, wherein the identifying at least one series hybrid driveline state so as to generate a vehicle deceleration that is equal to a deceleration setpoint for the vehicle comprises:
when at least one series hybrid driveline state conforms to the vehicle deceleration setpoint, a fifth selection comprising the series hybrid driveline state,
when no series hybrid driveline state conforms to the vehicle deceleration setpoint, a fifth selection comprising a driveline state other than the series hybrid driveline state.

17. The method as claimed in claim 16, wherein:
when the fifth selection comprises the series hybrid driveline state and the first selection comprises the series hybrid driveline state, the determining of the control vector for the gearbox wherein the coordinates associated with the at least one series hybrid driveline state are activated and the coordinates associated with at least one driveline state other than series hybrid are deactivated, the vector comprising all of the series hybrid, combustion engine and electrical driveline states,
when the fifth selection comprises the driveline state other than the series hybrid driveline state, the first selection comprises the series hybrid driveline state, and the second selection comprises the series hybrid driveline state, the determining of the control vector wherein the coordinates associated with at least one series hybrid driveline state are activated and the coordinates associated with at least one driveline state other than series hybrid are deactivated, the vector comprising all of the series hybrid, combustion engine and electrical driveline states, and
when the first selection comprises the electrical driveline state or when the second selection comprises the combustion engine driveline state and the fifth selection comprises the driveline state other than the series hybrid driveline state, the determining of the control vector wherein the coordinates associated with the vehicle driveline states producing a minimum deceleration equal to the vehicle deceleration setpoint are activated and the coordinates associated with at least one other vehicle driveline state are deactivated, the vector comprising all of the series hybrid, combustion engine and electrical driveline states.

18. The method as claimed in claim 17, wherein when the control vector comprises coordinates associated with more than one vehicle driveline state, the method comprises, for each driveline state of the control vector, the determining of the electrical energy dissipated, and the selection of the state that generates the lowest losses.

19. A control unit to control an automatic gearbox for a hybrid motor vehicle, comprising:
first selection means configured to select a driveline state from between an electrical driveline state in which an electric traction motor is connected to wheels of the vehicle via said gearbox and to a traction battery, and a series hybrid driveline state in which the electric traction motor is also electrically connected to an additional electric motor mechanically connected to a propulsion combustion engine, based on a target deceleration setpoint, coupling losses, and a state of charge of the traction battery;
second selection means configured to select a type of driveline from between a series hybrid driveline state and a combustion engine driveline state in which the combustion engine is connected to the wheels via the gearbox based on a speed of the vehicle, a minimum deceleration values of the driveline states, and a gearbox control setpoint for the gearbox;
identification means configured to identify at least one series hybrid driveline state so as to generate a vehicle deceleration that is equal to a deceleration setpoint for the vehicle;
determination means configured to determine a control vector for the gearbox comprising at least one driveline state based on the driveline state selected by the first and second selection means and the result of an identification from the identification means, and
control means configured to control the gearbox based on the control vector so that a first proportion of energy generated by the electric traction motor driven by the wheels is stored in the traction battery, and a second proportion of the energy powers the additional electric motor driving the combustion engine when the driveline state is a series hybrid driveline state when the control vector comprises a series hybrid driveline state.

20. A hybrid motor vehicle comprising:
the control unit as claimed in claim 19;
an automatic gearbox driving wheels of the vehicle and controlled by the control unit;
an electric traction motor connected mechanically to the gearbox;
a propulsion combustion engine connected mechanically to the gearbox;
an additional electric motor mechanically connected to the propulsion combustion engine; and
a traction battery connected to the traction motor and the additional motor.
